(19) United States
(12) Patent Application Publication
(10) Pub. No.: US 2010/0273273 A1
(43) Pub. Date: Oct. 28, 2010

(54) Sampling single phase from multiphase fluid

(76) Inventors: Peter Stephen Cross, Hamilton (NZ); Thomas Frietsch, Hamilton (NZ); Allan Walter Wilson, Hamilton (NZ)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/592,965

(22) PCT Filed: Mar. 29, 2005
(86) PCT No.: PCT/NZ2005/000058

§ 371 Date: Dec. 1, 2008

(30) Foreign Application Priority Data
Mar. 25, 2004 (NZ) 531794

(51) Int. Cl. G01N 1/10; G01F 23/00; G01N 21/35; G01N 21/55; G01N 1/00

(52) U.S. Cl. 436/174; 73/290 R; 356/51; 356/436; 356/445; 73/863.02

(57) ABSTRACT

A sampler (1) for extracting sample volumes of substantially single-phase fluid or gas from a fluid-flow system containing multi-phase fluids (3), said sampler (1) including; a collection recess (4) adapted to separate substantially single-phase fluid from said multi-phase fluid (3); an extraction outlet (8) in said collection recess (4); at least one fluid sensor system (5) capable of sensing the presence and/or state of said single-phase fluid or gas in the collection recess (4), a fluid controller (6) capable of controlling fluid or gas flow from the collection recess (4) via said extraction outlet (8), characterised in that said fluid sensor system (5) includes at least two distinct sensors respectively capable of utilising distinct properties of the fluid or gas to determine the presence and/or state of the sample volume present in the collection recess (4).

### TECHNICAL FIELD

The present invention relates generally to a sampler, in particular to a milk line sampler.

### BACKGROUND ART

Monitoring the constituents and characteristics of dairy milk, particularly during the milking process itself is of increasing interest to both producers and consumers. In addition to quantitative feedback on the milk value (determined by the percentage of fat solids), commercially and health/safety significant data on blood, water and fat content, mastitis, lactation and other conditions are also of interest.

Consequential developments in milk line monitoring and sampling have produced several prior art techniques, though these still possess disadvantages.

It is desirable to sample the milk in the milk line from the cow without causing any significant interruption to the milk flow or delay in obtaining the measured data.

It is also important to obtain accurately known volume samples of milk (or at least to obtain minimum sample volumes) as part of the testing processes for the various milk characteristics monitored. Difficulties arise in obtaining accurate (or minimum) milk volumes however, as the milk line flow from dairy cattle is not uniform but a largely two-phase flow of milk and air. Milk flow interruptions when a teat cup become detached from the animal or very low levels of milk flow also cause major problems in obtaining the minimum required sample size. The pulsed vacuum action applied to the teat cups produces a fluctuating milk flow including solid milk slugs, milk with entrained air and milk/air froth.

Consequently, determination of the instantaneous milk/air ratio at any given time is extremely difficult. Known techniques of extracting a measured sample volume such as disclosed in U.S. Pat. Nos. 5,572,946 and 5,388,549 Holroyd, involve opening a fluid outlet in the milk line at a predetermined time period after milking has commenced. The time period is chosen to correspond to a time when a solid milk flow is likely to be occurring and/or, dependant on the purpose of the sample testing: e.g. taking account of the significant fat variation between the fore milk and milk from the latter milking stages. However, this technique is not infallible and it is possible for the extracted sample to contain a significant quantity of air.

Further prior art means of addressing the above difficulties are disclosed in WO 00/64242 Dommerholt which, amongst numerous embodiments, describes a milk-sensing device using spectrometry to determine milk content. In order to perform measurements in non-turbulent single-phase milk, a light emitter/detector pair is arranged in a sample well. Different configurations permit either transmission measurements or reflectance measurements to measure changes in wavelength and scattering angles. However, there is no means of extracting a physical sample of the milk from the well to perform further testing, nor determining what type of sample is present, i.e. milk, froth or air.

WO 03/090522 Bosma, Holmertz also discloses a milk-sampling device which utilises a variety of methods to extract a sample from the milk line including a conduit loop and uses a timed milk flow through a control valve to rinse the sampler passageways of any milk residue from the previously milked animal. This system does not use a sample well to extract single phase milk nor consequently does it sense the specific presence of a specific volume of single-phase milk to trigger sample collection.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided a sampler for extracting sample volumes of substantially single-phase fluid from a fluid-flow system containing multi-phase fluids, said sampler including;
a collection recess adapted to separate substantially single-phase fluid from said multi-phase fluid;
an extraction outlet in said collection recess;
at least one fluid sensor system capable of sensing the presence of a minimum volume of said single-phase fluid or gas in the collection recess, and
a fluid controller capable of controlling flow from the collection recess via said extraction outlet;
   characterised in that
   a sample volume of said single-phase fluid or gas is obtainable by operating the fluid controller to allow the sample volume to flow through the extraction outlet after said fluid sensor has detected the presence of said minimum volume of single-phase fluid or gas in the fluid collection recess.

It will be appreciated that any sensor capable of sensing the presence of a particular liquid, gas or froth is by definition also capable of detecting an absence of same and that the present invention should be interpreted to include such a capacity of the sensors.

The term ‘fluid controller’ used herein refers to any suitable device or mechanism capable of receiving data input from the fluid sensor system, and performing processing or logical operations to control the flow of fluid or gas from the collection recess by operating a valve or pump or the like.

As used herein, “multi-phase fluid” includes a mixture of gas, fluid and froth (i.e. fluid and entrained and/or undissolved gas) whereas “single-phase fluid” is fluid substantially separated from undissolved gases or froth.

It will be appreciated that although obtaining single phase fluid sample volumes is of greatest importance in applications such as milk line sampling, the invention is not restricted to same. The invention may equally be utilised in applications such as the petrochemical field where extracting and sampling a gas from a multi-phase flow may be of prime importance.

Equally feasible, albeit with less likelihood of commercial importance, is the possibility of deliberately seeking to extract sample volumes of froth. To maintain clarity, the invention is largely described herein with respect to the extraction of single phase sample volumes, though it should be understood this is for exemplary purposes only and the invention is not limited to same.

In one embodiment, said sampler includes a pump controlled by said fluid controller to extract said sample volume from the collection recess.

In an alternative embodiment, the sampler includes a valve controlled by said fluid controller to allow the sample volume to pass from the collection recess.

In applications such as milking where a vacuum propels the multi fluid flow in the fluid flow system, a pump is required to positively remove the single phase fluid against the effects of the vacuum. If the multi-phase fluid flow is propelled solely by gravity, or by an elevated fluid pressure (e.g. super-atmospheric air) supply, a simple valve may be used by the fluid controller to regulate the flow from the collection recess.

The pump may be of variable or fixed fluid flow rate throughput, provided the throughput is known to enable the calculation of an accurate sample volume extraction.

Where only a minimum sample volume is required, any pump capable of pumping against a vacuum at a known flow rate may be employed. Utilisation of low inertia pumps with precisely controllable throughput enables the fluid controller to start and stop the pump as often as required by fluctuations in single-phase fluid level in the collection recess during the acquisition of the defined fluid volume required for sampling.

In milk line sampling, the milk flow from the animal is maintained by a vacuum applied to the milk line. Consequently, a further function of the fluid controller and pump is to seal the fluid extraction outlet from the effects of the vacuum during and after collection of the samples.

In one embodiment, the fluid sensor is configured as a simple fluid level detector, preferably positioned to detect the presence of single-phase fluid at a position in the collection recess indicative of sufficient single-phase fluid volume to extract said defined volume sample.

In alternative embodiments, additional fluid level detectors may be employed to provide data on fluid level change and/or rate of fluid level change. Thus, providing an additional fluid sensor above the first fluid sensor provides advanced warning to the fluid controller that the fluid level in the collection recess is trending to fall below the level necessary to extract a defined volume sample. Where the sample volume contained in the extraction well below the level detector is very small, an indication of the rate of level change may be omitted without affecting the functionality of the sampler.

Alternatively, the fluid sensor may continuously measure the absolute single-phase fluid level within the extraction recess.

Numerous forms of known fluid sensor may be employed, both invasive (inside the collection recess) and non-invasive, including optical, electro-optical, electrical capacitance, acoustic, pressure sensors or the like.

In milk sampling applications, the presence of single-phase milk may be determined by an optical emitter and detector by measurement of the attenuation of the light signal transmitted through the fluid.

In yet further embodiments, the fluid sensor may be configured to detect the absence of fluid, preferably including single or multi-phase fluid. This configuration may provide continuous data to the fluid controller on the instantaneous status of fluid in the collection recess.

In one embodiment, a predetermined or minimum sample volume of said single-phase fluid is obtainable by operating the fluid controller to allow fluid to flow through the extraction outlet for a predetermined period after said fluid sensor system has detected the presence of single-phase fluid at said predetermined level in the fluid collection recess.

Preferably, a predetermined or minimum sample volume of said single-phase fluid or gas is obtainable by operating the fluid controller to allow fluid to flow through the extraction outlet until
a predetermined time has elapsed;
a pump operable by the fluid controller has pumped said minimum volume from the collection recess;
a second level sensor located at a lower point in the collection recess indicates the absence of the sample volume fluid or gas; and/or
   a flow rate sensor monitoring flow from the extraction outlet indicates flow has dropped below a predetermined level.

According to a further aspect, the present invention provides a sampler for extracting sample volumes of substantially single-phase fluid or gas from a fluid-flow system containing multi-phase fluids, said sampler including;
a collection recess adapted to separate substantially single-phase fluid from said multi-phase fluid;
an extraction outlet in said collection recess;
at least one fluid sensor system capable of sensing the presence and/or state of said single-phase fluid or gas, at a predetermined level in the collection recess,
a fluid controller capable of controlling fluid or gas flow from the collection recess via said extraction outlet;
   characterised in that said fluid sensor system includes
   at least two distinct sensors respectively capable of utilising distinct properties of the fluid or gas to determine the presence and/or state of the sample volume present in the collection recess.

According to a yet further embodiment of the present invention, said properties of the fluid or gas include transmission/absorption, refractive index, reflectance, back-scattering, opacity, capacitance, inductance, conductivity, electrical resistance, dielectric constant, ultrasonic, magnetic or acoustic.

In a preferred embodiment, said fluid sensor system includes
a total internal reflection sensor including an emitter and a detector, and
a transmission sensor including an emitter and a detector arranged on substantially opposing sides of the collection recess.

Preferably the state of a sample volume determined by the fluid sensor system includes at least one of; single phase fluid, froth, or gas.

The use of at least two sensors utilising different properties of the fluid or gas permits the characteristics of the sensors to be matched with the characteristics of the type sample volume desired for extraction and sampling.

By way of example, in an embodiment such as a typical milk line, the fluid-flow system may include milk (single phase and froth), air, cleaning fluid such as wash water, or tap water in addition to a film or residue of tap water, wash water or milk which may remain over the sensors in the recess walls after extraction of the sample volume. Table 1 below shows the outputs for different types of sensors with the presence of the above mediums.

TABLE 1

| | Sensor output with collection recess contents of | | | | | | |
|---|---|---|---|---|---|---|---|
| | | | | | | | Wash |
| | | | Tap | | | Wash | Water |
| Method | Air | Tap Water | Water Film | Milk | Milk Film | Water | Film |
| Optical | 0 | 0 | 0 | 1 | 0 | 0 | 0 |
| Transmission | | | | | | | |
| Optical Total | 0 | 1 | 0 | 1 | 0 | 1 | 0 |
| Internal | | | | | | | |
| Reflection | | | | | | | |
| Optical | 0 | 0 | 0 | 1 | 0 or 1 | 0 | 0 |
| Backscatter | | | | | | | |
| Capacitance | 0 | 1 | 0 | 1 | 1 | 1 | 1 |
| Impedance | | | | | | | |
| Measurement | | | | | | | |
| Capacitance | 0 | 1 | 0 | 1 | 0 | 1 | 1 |
| Charge | | | | | | | |
| Transfer | | | | | | | |
| Conductivity | zero | low | very | high | medium | very | medium |
| | | | low | | | high | to |
| | | | | | | | high |

It will be appreciated that where a sensor type outputs the same value for two different types of medium, a second sensor may be chosen that exhibits a different response to at least that medium to remove the measurement ambiguity. Optical transmission sensors can distinguish between air and single phase milk, but are unable to readily distinguish between air and tap water or wash fluid. By adding a total internal reflection sensor to the fluid sensor system, it can be seen from table 1, that the sampler is able to uniquely identity milk (the only combination with a (1, 1) sensor output, and is able to group tap water/wash water, and air/tap water film/milk film/wash water film. Typically, either tap water or wash water would be used for cleaning purposes and thus there is no need to distinguish between each other. Similarly, a (0, 0) sensor output narrows down to either air or a film or either milk or cleaning fluid. Thus, by configuring the sampler to avoid the possibility of films covering the sensors (as described more fully below), the sampler can distinguish between air, single phase milk, and cleaning fluid by using a optical transmission and a total internal reflection sensor. It can be readily seen that a number of permutations are possible, dependant on the medium of interest and the nature of the fluid flow.

Thus, according to a further aspect of the present invention, said at least two distinct sensors are capable of distinctive outputs from sensing the sample volume in comparison to sensing any other components of said multi-phase fluid in the fluid flow system.

According to a further aspect, the present invention provides a method of configuring a sampler as hereinbefore described, said method including the step of;
selecting said two or more sensors for the fluid sensor system such that sensing the presence and/or state of a sample volume for subsequent extraction from the collection recess produces a distinct out put from the fluid sensor system sensors in comparison to sensing any other components of said multi-phase fluid in the fluid flow system sensed in the collection recess.

The present invention also provides a sampler capable of intermittent extraction of a specific fluid or gas or a specific phase of fluid/gas from a multi flow system, said extraction being halted during periods when one or more unwanted fluid/gas phases are present in the collection recess. Thus, the sampler may continually extract single phase milk for example, yet cease extraction whenever froth, air, cleaning fluid or water are sensed in the collection recess.

Sampling is preferably delayed for a short period after milk flow commences as the initial milk from a cow possesses different properties from the main milk flow. Preferably, the sampler is capable of intermittent extraction of a specific fluid or gas or a specific phase of fluid/gas from a multi flow system, said extraction being halted during periods when one or more unwanted fluid/gas phases are present in the collection recess.

In a further embodiment, extraction of the sample volume may be delayed for a predetermined period after commencement of fluid flow in the fluid flow system.

Although the combination of a transmission sensor and a total internal reflection sensor offer complimentary benefits, alternative sensor technologies also offer certain characteristics which may be desirable in certain applications.

Capacitance sensors are available in numerous forms including impedance and charge transfer based capacitive sensing. Impedance based capacitance sensors consist essentially of a pair of electrodes that form a capacitor with the material to be sensed (i.e. the collection recess forming the dielectric between the plates. Different materials alter the dielectric properties resulting in the detection of a different capacitance. The capacitor may work with an oscillator to form a tuned circuit, and changes in the dielectric are detected by changes in the operating frequency. Thus, in the present invention, the electrode plates are placed either side of the collection recess. Alterations in the fluid, gas, or froth in the collection recess would alter the dielectric constant consequently altering the measured impedance.

However, although impedance based sensors operate successfully for non-conductive fluids, they can encounter difficulties with conductive fluids such as milk. Milk residue forms two conductive plates inside the collection recess, which presents substantially the same impedance as a well full of milk.

This difficulty may be addressed by the use of charge transfer capacitance sensors which also use the same physical arrangement of the electrodes on opposing sides of the collection recess. The plates are charged with a voltage for a short duration and then discharged through a measuring circuit and the time measured for the voltage to decay to determine the capacitance. The dielectric constant of the substance in the collection recess can also be measured. By careful control of the charging and discharging cycle, the effects of film of milk residue are largely overcome.

Capacitance sensors are available in numerous forms including impedance and charge transfer based capacitive sensing. Impedance based capacitance sensors consist essentially of a pair of electrodes that form a capacitor with the material to be sensed (i.e. the collection recess forming the dielectric between the plates. Different materials alter the dielectric properties resulting in the detection of a different capacitance. The capacitor may work with an oscillator to form a tuned circuit, and changes in the dielectric are detected by changes in the operating frequency. Thus, in the present invention, the electrode plates are placed either side of the collection recess. Alterations in the fluid, gas, or froth in the collection recess would alter the dielectric constant consequently altering the measured impedance.

However, although impedance based sensors operate successfully for non-conductive fluids, they can encounter difficulties with conductive fluids such as milk. Milk residue forms two conductive plates inside the collection recess, which presents substantially the same impedance as a well full of milk.

This difficulty may be addressed by the use of charge transfer capacitance sensors which also use the same physical arrangement of the electrodes on opposing sides of the collection recess. The plates are charged with a voltage for a short duration and then discharged through a measuring circuit and the time measured for the voltage to decay to determine the capacitance. The dielectric constant of the substance in the collection recess can also be measured. By careful control of the charging and discharging cycle, the effects of film of milk residue are largely overcome.

Conductivity sensors may also be used to sense the presence and/or state of a fluid/gas in the collection recess, though it does require the electrodes to be in contact with the fluid/gas. In a simple conductivity sensor two probes are positioned through opposing sides of the collection recess and the current flow between them is measured to determine the impedance of the medium in the collection recess. An alternating current prevents electrolysis at the probe surfaces. The frequency may also be varied to provide further information on the medium present in the collection recess. However, the build up of residue on the probes may affect two probe sensors, generating false readings. This may be overcome using a 4-probe system where one pair of probes maintains a constant current and a second pair of high impedance probes measures the voltage. This has the advantage of largely cancelling the effects of dirt build-up, as the voltage is only measured by the high impedance probes which are less affected by residue build up. The probes still require carefully positioning as an empty collection recess with just a high conductivity fluid film (e.g. acid-based wash water) present can produce the same reading as a collection recess full of low conductivity fluid (water). Conductivity sensors can be used to check for the presence of any type of fluid in comparison to a gas e.g. air. They can also distinguish between water, milk and wash water, except in the following circumstances.

Dilute wash water can display the same conductivity as milk. Pure milk has a conductivity of 1-10 milliSiemens. Pure water has a lower conductivity and wash water has a much higher conductivity. However, ambiguity occurs when mixtures of substances occur, e.g. tap water with a very small amount of residual wash water will display the same conductivity as milk. Such mixtures may easily arise in a rinse following a wash procedure.

Wash water is generally a mixture of tap water and either acid or alkali, whereas tap water is generally from a farm bore or the like.

A wash procedure typically involves:
cows finish milking;
tap water pushing milk through to the milk vat to help avoid any milk remaining in the fluid flow system from being wasted;
the milking system being isolated from milk vat;
a cold rinse with tap water to remove main milk residue;
a hot water and acid, or hot water and alkali rinse to remove milk films, and
a water rinse to remove acid or alkali.

Consequently, it is possible for the collection recess to contain;
air
foam of milk and air
pure milk
pure water
wash water
a mix of tap water and milk
a mix of tap water and wash water

The present invention provides a means to resolve this uncertainty by the addition of a secondary sensor (e.g. a transmission sensor) specifically selected to provide a distinguishing response between the mixtures and milk. Alternatively, the sampler may receive information from an external source that a wash cycle is in progress. This may provide a partial means of overcoming this difficulty in a sampler already including two sensor types optimised to distinguish between different mediums without the need for a third sensor type.

Charge-transfer based capacitive sensors can also suffer from a comparable problem in that a small amount of fluid with a high dielectric constant can give similar results to a larger volume of fluid with a low dielectric constant. This can be overcome by a collection recess configured with a small volume such that there is likely to be fluid between the reference plates virtually continuously.

The aforementioned sensor types are provide as an illustration of the different fluid sensor system configurations possible and are not limiting. Optical transmission and total internal reflectance sensors have been found an effective combination for milk line sampling and the present invention is described further with respect to these two sensor types.

In one embodiment, the total internal reflection sensor and transmission sensor may use one of more common emitters and/or detector.

In a preferred embodiment, each sensor includes an individual emitter and a single detector common to both sensors, wherein the emitters are near infra red (NIR) LEDs and the detector is a photo-diode.

Preferably, the total internal reflection and/or the transmission sensor are/is located at said predetermined level in the collection recess.

Preferably, the total internal reflection sensor emitter and detector are orientated towards a common point on a wall of the collection recess and positioned substantially symmetrically either side of an axis orthogonal to the wall and passing through said common point.

In a further aspect of the present invention, the fluid controller incorporates a processor capable of receiving output signals from both the total internal reflection sensor and the transmission sensor and comparing said outputs with predetermined reference data to determine whether single phase fluid, froth, or gas is present in the collection recess.

It has been determined that the presence of single phase fluid (e.g. milk or water), froth (e.g. milk and air bubbles), or as (e.g. air) produces specific readings from the total internal reflection sensor and transmission sensor enabling the compilation of said reference data records indicative of the substance state. Thus, the fluid sensor system measurements obtained from sample volumes of substance from the fluid-flow system are compared with said data records to determine the corresponding state of the substance.

The need for both the transmission and total internal reflection sensors is due to non-linearity in the response of milk (as described below), though it will be appreciated that sampling of other fluid types may dispense with the need for one of the sensors.

The transmission of light through a medium varies due to both the refractive index and the chemical bonds present, due to the atoms absorbing the lights energy as it passes through the medium. Light transmission is also wavelength dependent. Therefore, by measuring the intensity of light passing through a medium an indication of its composition may be established. The values specific to that medium may then be used to identity that medium in situations where multiple mediums, may be flowing in the same line. However, it has been found that milk does not exhibit a linear progression in absorption between the three mediums (i.e. single phase, froth and air), primarily due to the variation in milk solids. Consequently, an additional sensing means (i.e. the total internal reflection sensor) is utilised to distinguish between the mediums.

The total internal reflection sensor operates on well established optical principles. At a planar boundary between two media with refractive indices n₁ and n₂ the relation between the angles of refraction and incidence, θ₁ and θ₂ (with respect to an axis orthogonal to the boundary surface), is governed by Snell's law which states that:

n₁ sin θ₁=n₂ sin θ₂

Although this relation applies to both external and internal refraction, only internal refraction is germane to the present invention.

If the incident ray is in a medium of higher refractive index (nᵢ>n₂) than the secondary medium, the exit ray is refracted towards the boundary. Total internal reflection occurs when θ₁=θ_{c} (the ‘critical’ angle), with n₁ sin θ_{c}=n₂, so that θ_{c}=sin⁻¹ (n₂/n₁).

When θ₁>θ_{c}, Snell's law cannot be satisfied and instead of being refracted, the incident ray is totally reflected off the boundary surface. In the present invention, the total internal refection sensor is positioned such that one of the walls of the collection recess acts as the reflective boundary surface, with the emitter and detector components set into the wall material itself. By mounting the emitter and detector at 45° to the axis orthogonal to the boundary surface, then air is present in the collection recess (i.e. n₂=1) and if n₁>√2 then θ_{c}<45° [i.e. θ_{c}=sin⁻¹((n₁>√2)/1)=<45];

Since θ₁=45°, θ₁>θ_{c} the incident emitter ray is totally reflected.

In the case where the medium is water or milk, n₂ ≠1, some of the light is refracted into the collection recess and the light intensities received by the detector are consequently reduced. These measured values may then be used in comparison with the corresponding values obtained with the transmission sensor to establish said unique reference data records denoting each of the three phases. The phase of the substance in the recess may thus be determined by comparison of the measured values with the reference data record values from both sensor types for each phase.

Preferably, said fluid sensor system further includes an analogue and digital controllers, said analogue controller capable of processing output signals from said detectors and providing an input signal to said emitters, said digital controller incorporates said processor and interfaces with the analogue controller to receive, process and convert the analogue signals into equivalent digital signals, before the processor compares the detectors outputs with said data records to determination, the state of the substance. Preferably, the processor outputs a signal to a display indicating the phase of the medium in the sample recess. If a specific medium is required for sampling, e.g. single phase milk, the processor operates a pump to allow fluid to flow through the extraction outlet for a predetermined period after single phase milk has detected.

As both sensors operate on optical principals, variations in the ambient light level may cause inaccuracies. This is addressed by selectively switching the emitters, so that the ambient light received by the detector is measured with all the emitters switched off. This value is then subtracted from the detector output signal when measuring the emitter signals from the both sensors.

Thus, according to one aspect of the present invention, the detector output measured with all emitter switched off is subtracted from the detector outputs measured when a transmission emitter or total internal reflection emitter is on. According to one aspect of the present invention, upon detection by the fluid sensor of the absence of said fluid or gas, the fluid controller may activate said pump or valve to allow the passage of non-dissolved gas to form a substantially non-fluid buffer between single fluid samples.

A further benefit of using both a transmissive and a total internal reflection sensor is in determining the opacity of the substance in the collection recess. This may be useful in a variety of applications such as when sampling non-milk fluids and also when flushing a sampling system with a cleaning fluid such as water. In milk-line sampling operations, a cleaning flush may be performed between individual samples, or at the end of a batch of sampling, or at any other chosen point desired by the operator. Clearly, it is desirable for the system to determine what substance is in the collection recess to identify when;
sampling may resume again,
all traces of the previous sample has been flushed,
a film of the sample remains over the walls in any otherwise empty collection recess.

In addition to the above identification capabilities, a measure of the opacity enables the sampler to trigger certain events such as wash cycles for down stream processing units. Thus, according to a preferred embodiment, the present invention the opacity of any fluid in the collection recess is determined by the fluid sensor system by comparison of the fluid sensor system detector output with said data records to identify the presence of single phase milk, water, cleaning fluid, or a combination of same.

The detection of the absence of said fluid by the fluid sensor may also be used to instigate an evacuation of the sampler (for cleaning or the like) by pumping undissolved gas or a cleaning fluid through any sampler fluid paths.

The possibility of a residual thin film of fluid which remains over the detectors after a milk slug has passed can cause measurement errors. This possibility maybe attenuated in a circular cross-section conduit fluid-flow system (such as a typical milk line) by placing the entrance to the collection recess slightly above the lowermost point of the conduit. This effectively provides a small lip which collects residual small fluid deposits and prevents them running over the sensors in the collection recess walls. One simple method of achieving this configuration is by rotating the conduit about its longitudinal axis until the collection recess is located at approximately 45° from a position at the lowermost point of the conduit. Alternatively, a small rim may be formed about the collection recess entrance.

The acquisition of an accurately measured volume of single-phase sample fluid may be desirable in a range of applications aside from testing milk obtained from milk lines. Further reference to the use of the present invention in milk line sampling should be understood to be exemplary and not limiting.

After acquisition, the sample fluid may be processed by a number of techniques according to the particular fluid characteristic or constituent of interest.

According to one embodiment, the defined fluid volume extracted may be temporarily retained in a storage vessel before transportation to a sample processor. In a further embodiment, multiple fluid samplers may be combined to extract a plurality of fluid samples which may be combined together in a common storage vessel or stored in individual storage vessels until subsequent testing at the sample processor.

In a further embodiment, at least one additional fluid sensor is incorporated into the sampler at a downstream position from the fluid extraction outlet. Preferably, a said additional fluid sensor is located in said storage vessel.

Thus, the fluid controller receiving input from the additional fluid sensor may also determine or confirm whether the single-phase sample fluid was present in the storage vessel. Knowledge of the storage vessel volume would permit a further or independent means of verifying the absolute or minimum fluid sample volume. This reduces the need for an accurate knowledge of the fluid flow rate through the pump or valve controlled by the fluid controller.

In a yet further embodiment, the storage vessel may be dispensed with altogether and the conduits themselves used to retain the extracted sample volumes prior to testing at the sample processor. This confers several advantages including the cost saving in omitting the storage chamber and the ease of use and cleaning. Nevertheless, it is necessary to ensure the separate samples are discernable from each other and are prevented from cross-contaminating each other. The necessary separation may be provided by pumping gas (preferably air) between successive samples to provide a segmenting buffer.

Thus, according to a further embodiment, the sampler system is capable of pumping a gas volume between successive extracted samples to form gas buffers. Preferably, said extracted sample volumes are temporarily storable in fluid path conduits connected to said extraction outlet. In milking applications, it may be desirable to monitor the milk quality from each animal individually and even from each teat.

In alternative applications (such as the petrochemical fields) where a gas forms the desired sample volume, small fluid buffers may be used to segregate successive gas sample volumes.

The sample processor may be configured to perform a variety of tests on the sample fluid such as (in the case of milk sampling) mastitis, lactate or progesterone detection/monitoring.

Currently, mastitis is detected in a number of ways including initial detection by the farmer of clots on the milk filter. This can indicate to the farmer that there is mastitis in the herd. Naturally, this method of detection cannot prevent contamination of the milk vat for that milking day. However, the farmer can be alerted to check every teat in his/her herd, either by visually assessing if there is infection and/or squirting milk from the teat onto the milking shed floor to determine if there are clots therein.

Another method used to detect mastitis is somatic cell counts. This normally involves taking a sample of milk from the cow and then sending the sample to a laboratory to be tested in a specialised and expensive cell counter machine.

This test has the advantage of good results in detecting sub-clinical mastitis, but has the disadvantage in that the test is only undertaken at intervals usually of at least one week. In New Zealand, routine somatic cell counts are undertaken daily on a bulk milk sample from the milk vat. The presence of mastitis in the herd can be detected by a sudden increase in somatic cell concentrations but the farmer is then faced with the problem of finding the infected quarter(s) in the herd.

Consequently, detecting mastitis by an accurate automated process undertaken concurrently with the milking process offers numerous advantages.

Thus, according to one embodiment, the present invention further includes a sample processor for performing mastitis detection, said sample processor including; an inlet from one or more sample storage vessels; a mixing chamber, with a reagent inlet and an outlet draining to a flow chamber.

In an alternative embodiment, said sample storage vessels are fluid conduits.

The present invention further provides a testing method to aid in the detection of mastitis using the sampler as hereinbefore described, said method characterised by the steps of:
sensing the presence of single-phase fluid in the collection recess at a predetermined height;
activating said pump for a predetermined period to extract a defined or minimum volume of single-phase fluid sample via the fluid extraction outlet;
transporting the fluid sample to the mixing chamber in said sample processor;
mixing a reagent with the fluid sample to form a gel;
obtaining an indication of somatic cell numbers by measuring the time the gel needs to drain through a defined exit hole;
determining if the drain time exceed a predetermined threshold value or range of values.

In order to determine the presence of mastitis, the above measurements are used in conjunction with historical data, e.g. cell counts from previous milking, as part of a herd management system. Increased drain times due to more viscous gel are caused by an increase in the number of somatic cell numbers, itself an indicator of mastitis.

In one embodiment, said viscosity measurement is performed by monitoring the time taken to drain the gel though a fixed size outlet.

In a further embodiment, one or more fluid sample(s) is/are temporarily stored in one or more sample storage vessel(s) before transportation to the sample processor.

It will be appreciated that the above-described testing for mastitis is but one embodiment of the present invention and alternative testing procedures may be performed on the extracted fluid sample.

### BRIEF DESCRIPTION OF DRAWINGS

Further aspects of the present invention will become apparent from the following description which is given by way of example only and with reference to the accompanying drawings in which:

FIG. 1 shows a schematic representation of a preferred embodiment of the present invention of a fluid sampler;

FIG. 2 shows a schematic representation of a four quarter sampling unit;

FIG. 3 shows a schematic representation of the four quarter sampling unit of FIG. 2 connected to a fluid sample processor;

FIG. 4 shows a further schematic representation of a sampling unit connected to a fluid sample processor;

FIG. 5 shows a cross-section side elevation through a milk line and fluid sampler;

FIG. 6 shows a plan view of a cross-section along XX shown in FIG. 5;

FIG. 7 shows transmission sensor data for different mediums according to a further preferred embodiment;

FIG. 8 shows a total internal reflection sensor data for different mediums according to a further preferred embodiment;

FIG. 9 shows a schematic block diagram of a fluid controller according to a further preferred embodiment;

FIG. 10a-b) show a schematic diagram of a back scattering sensor according to a further preferred embodiment;

FIG. 11a-b) show a schematic diagram of a capacitance sensor according to a further preferred embodiment, and

FIG. 12a-b) show a schematic diagram of a conductivity sensor according to a further preferred embodiment.

### BEST MODES FOR CARRYING OUT THE INVENTION

The figures show one embodiment of the present invention of a sampler in the form of a milk line sampling system (1) comprised generally of a milk line (2) containing multi-phase milk (3) flowing from a cow (not shown) under vacuum (not shown), a fluid collection recess in the form of a sample well (4), a fluid sensor system in the form of fluid sensor (5) interfaced with a fluid controller unit (6) and a pump (7) controlled by the fluid controller unit (6) and located in a fluid flow path from the sample well (4) via a fluid extraction outlet (8). The output of the pump (7) is temporarily retained in a storage vessel in the form of a conduit (9) before introduction to a sample processor (10) also interfaced with the fluid controller unit (6). The output of further pumps (7) from additional corresponding milk line sample extraction systems (1) may also be temporarily retained in a corresponding conduit (9) before analysis in the sample processor (10).

Although the current embodiment is described with reference to use in a milk line_application, it will be appreciated that alternative applications are possible and that the invention need not be so restricted.

Milk from a cow (not shown) is removed from each individual quarter teat by means of an automated milking system and travels along the milk line (2) under the effects of a pulse vacuum applied to the milk line (2). As an inherent consequence of the pulse milking system and the innate variability of the milk emanating from the animal, the milk also combines entrained air and/or undissolved gas (predominantly air) in a multi-phase milk flow (3). Consequently, it is not possible to simply extract a portion of the milk flow due to the uncertainty of the sample composition, i.e. the percentage volume of milk liquid and air.

Consequently, the sample well (4) is formed on the lower portion of the milk line and consists broadly of a tapered side profile with an elongated profile aligned along the longitudinal axis of the milk line and comparatively narrow in the lateral direction.

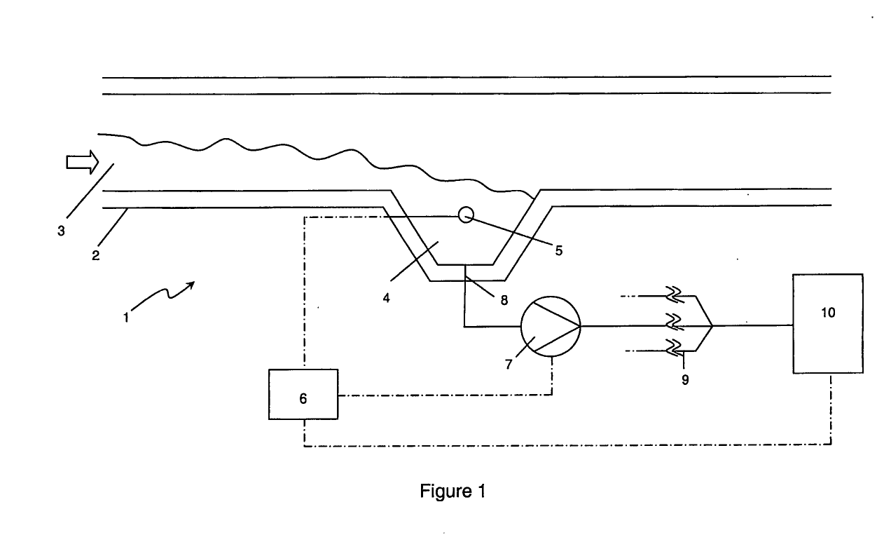

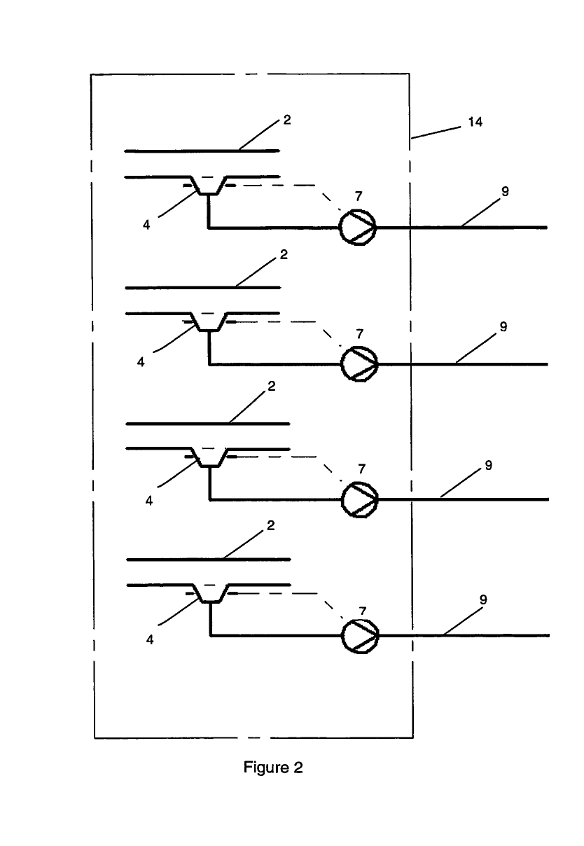

As multi-phase milk (3) flowing along the milk line (2) passes over the sample well (4), the single-phase portion of the milk (11) (i.e. substantially homogenous milk without entrained air or other undissolved gasses) flows into the recess under the action of gravity. The fluid sensor (5) positioned at a predetermined point above the bottom of the sample well (4) is used to detect the presence of said single-phase milk (11) at the height of the fluid sensor (5). It will be appreciated that the fluid sensor (5) may be configured to detect either the presence or the absence of fluid without affecting the functionality of the sampler (1). The fluid controller (6) receives input from the fluid sensor (5) and upon detection of single-phase fluid (11) at the height of the fluid sensor (5), activates the pump (7) to extract a defined volume of single-phase fluid from the sample well (4) via a fluid extraction outlet (8). The use of a peristaltic pump (7) or any other suitable pump of known flow rate enables precise control over the defined volume of single-phase fluid (11) extracted with the consequential improvement in subsequent tests performed on the fluid (11). The defined volume of extracted fluid sample extracted from the sample well (4) is then temporarily stored in conduit (12) before transportation to the sample processor (10). As shown schematically in FIG. 1, multiple milk sampling systems (1) temporarily storing their respective samples in further conduits (9) may be combined to provide a single fluid inlet (13) to the sample processor (10). FIG. 2 shows an embodiment with a four-quarter sampling unit (14) as may be used to sample milk from the individual quarters of a cow's udder. However, if the sampling extraction is delayed from an individual teat for some reason (e.g. a teat cup becoming detached) it is not possible to process the previous sample in the mixing chamber (15). However, cross contamination of the samples may be avoided by a configuration (not shown) utilising separate fluid inlets (13) for each conduit (9). Obtaining each of the four samples from the individual teats separately enables precise monitoring of the milking process of the various constituents of interest obtained from each quarter.

Successive samples being stored in respective conduits (9) may be separated by pumping small air buffers between the fluid samples. Whilst avoiding cross-contamination between samples, it also provides a useful triggering means (for activating sample processing, cleaning cycles, and so forth) for sensors capable of distinguishing between fluid and gas.

In alternative embodiments (not shown), further fluid sensor(s) (5) may be located at one or more points ‘downstream’ of the fluid extraction outlet (8), such as in each conduit (9). This configuration reduces the reliance on measuring the flow passed through the pump (7) as the required sample volume or minimum volume may be simply calculated from the knowledge the fluid is at a known point (i.e. the position of the fluid sensor 5)) within the sample conduit (9) of known volume.

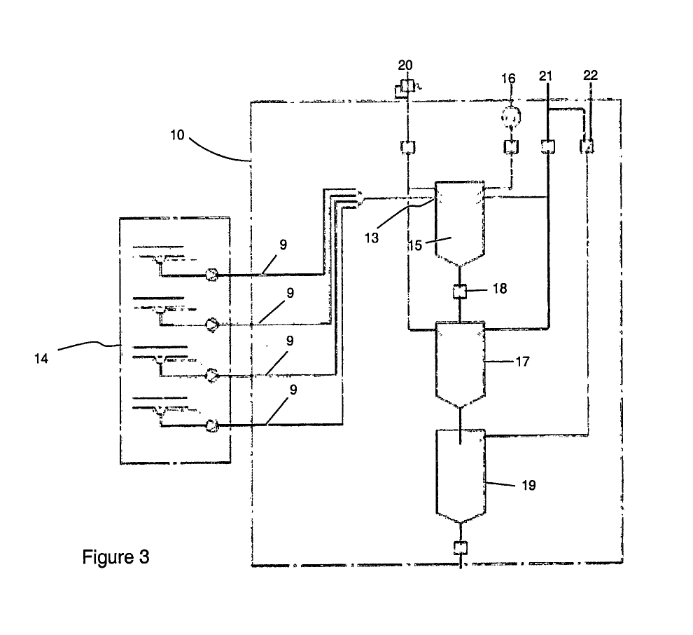

Numerous testing procedures may be performed on the extracted fluid volume. FIG. 3 shows a schematic representation of an embodiment for performing viscosity measurements in the sample processor (10). Viscosity measurements are used as part of an established test for mastitis known as the California mastitis test or CMT. The test is a measure of the somatic cell counts or SCC, whereby the milk is mixed together with a reagent such as detergent. The viscosity of the resulting gel (due to the presence of DNA of cells and detergent mixing together) is a possible indication of bacterial infection. If the SCC is increased above a certain threshold, the gel increases in viscosity, indicating possible mastitis.

Alternative tests (not shown) include lactate testing, progesterone and the like.

In use, after the respective sample volumes have been stored in the four conduits (9) from the four quarter sampling unit (14) the fluid controller (6) sends a further signal to one of the pumps (7) to pump its sample into a first mixing chamber (15) where it is mixed with a reagent pumped from a separate inlet (16) to the first mixing chamber (15) the reagent and milk sample react to form a gel which is released into a flow cell (17) via a valve (18).

After a specified period, the gel mixture is released from the flow cell (17) into a waste chamber (19) below the flow cell (17). The time taken to drain the gel fluid from the flow cell (17) is indicative of the viscosity of the gel giving a means of estimating the somatic cell count (SCC) to detect possible mastitis in the animal.

The same procedure may then be performed sequentially with the fluid samples obtained from the other samplers (1) in the 4 quarter sampler (14). However, to avoid cross-contamination, numerous cleaning cycles may be performed. In the embodiment shown in FIG. 3, a portion of the sample volume is sacrificed by being pumped from the system to waste, thus positively expelling any remaining fluid from the previous sample. Furthermore, after the final fluid sample has been tested and milking has ceased, the pumps are operated to expel any remaining fluid in the conduits (12) in preparation for the next milking session.

During a cleaning of the actual milking system (including the milk lines) with hot or cold water (and optionally chemicals such as acid and/or alkaline), the sampler (1) may also be cleaned by running the pumps to flush the system with the cleaning fluid. The sample processor (10) shown in FIG. 3 also includes separate inlets for water (20) and atmospheric pressure (21) connected to the first mixing chamber (15) and the flow cell (17) and a vacuum line (22) connection to the waste chamber (19) to aid in the functioning and cleaning of the sample processor (10). The above described embodiment is schematic only and numerous variations are possible including omitting the external water (20), and/or vacuum (22) lines.

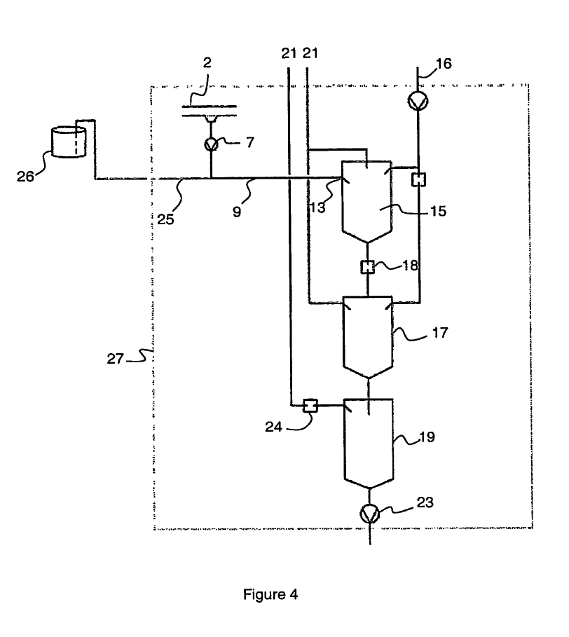

In a further embodiment (shown in FIG. 4), the external water (20) cleaning is omitted and vacuum (22) is replaced by a peristaltic pump (23) at the outlet of the waste chamber (19) in conjunction with a bleed valve (24) for the atmospheric supply (21). The embodiment shown in FIG. 4 shows sampling obtained from a single a single milk line (9) only with an optional inlet (25) for bench-top testing supply (26). The milk line (2) including sample (4) well and pump (7) have been accommodated in the sensor enclosure (27) to eliminate the need for a separate sampler enclosure (14).

In yet further embodiments, the functionality of the above-described sampler may be enhanced by utilising a fluid sensor system with a plurality of sensors and through configurational alterations.

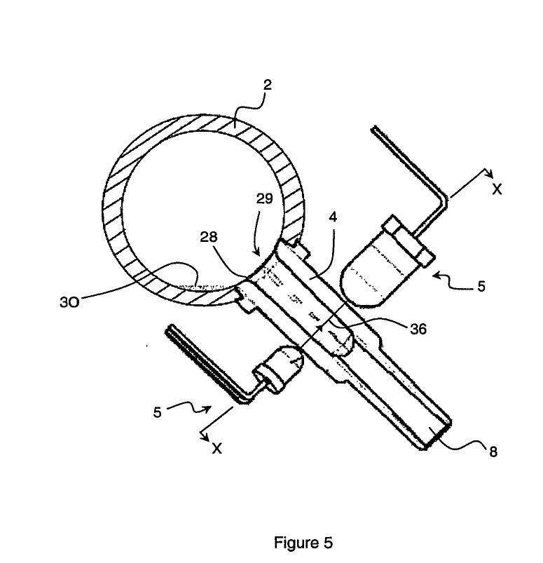

Any residual film of fluid (3) which remains over the detectors after a milk slug has passed and a sample extracted from the well (4) can cause measurement errors. FIG. 5 shows a cross section through the milk line (2) and well (4) whereby the sample well (4) is rotated from the lowermost point to lie at approximately 45° to the vertical. This has the effect of raising the edge (28) of the entrance (29) of the sample well (4) above the lowermost point of the milk line (2). Consequently, any small residual volume of fluid (30) collecting in the bottom of the milk line (2) will not enter the sample well (4). It will be appreciated the same effect may be produced by a number of configurations (not shown) such as forming a small rim about the entrance (29) of the collection recess (4) which may be located vertically at the bottom of the milk line (2). Alternatively, the sample well (4) may be vertically orientated with an off centre entrance (29). However, both such alternatives may present additional turbulence to the milk flow which would be undesirable.

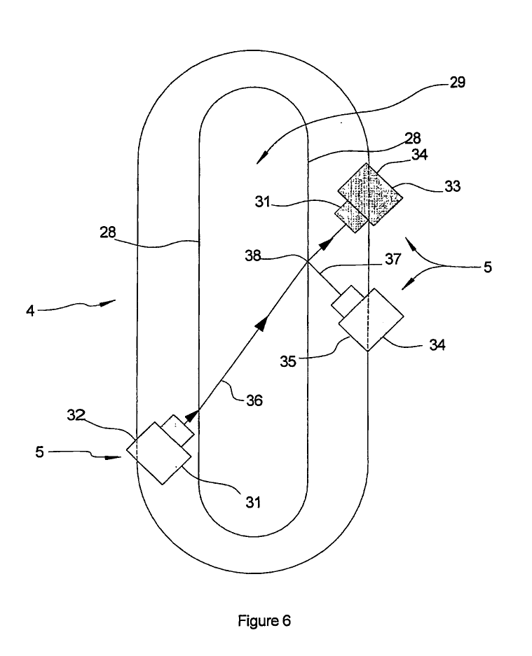

FIG. 5 also shows the fluid sensor (5) located at a predetermined height above the fluid extraction outlet (8). FIG. 6 shows a cross section through the sample well (4) in the plane XX (shown in FIG. 5). In the embodiment shown, the fluid sensor (5) includes a transmission sensor (31) comprised of an NIR LED emitter (32) and a photodiode detector (33) and a total internal reflection sensor (34) comprised of a further NIR LED (35) and the same photodiode detector (33) used in the transmission sensor.

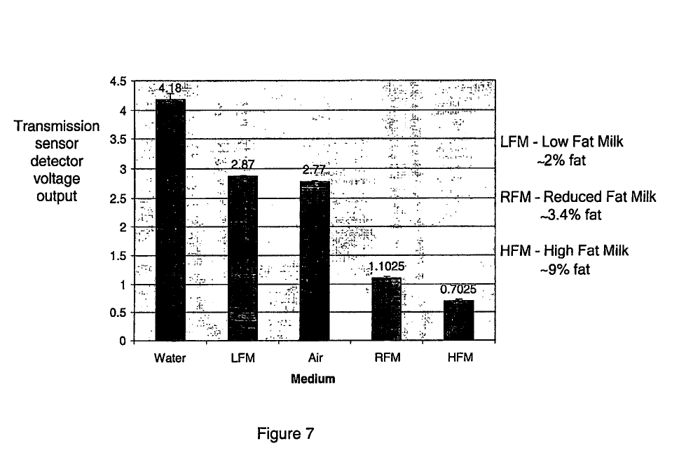

In operation, the transmission sensor (31) emits a light beam (36) from the emitter (32), through both walls of the well (4) via the contents of the well (4) to be received by the detector (33). According to a number of factors including the incident wavelength and the different refractive index and absorption properties of any substance in the well (4) such as single phase milk (11), water, air of the like, the intensity of the detected signal differs. FIG. 7 shows the mean voltage output of the transmission sensor (31) for milk of differing fat content, water and air. It can be readily seen that the results do not posses a linear progression in absorption between the three mediums. Consequently, the transmission sensor (31) in isolation is not sufficient to uniquely identify the substance in the well (4) or its phase.

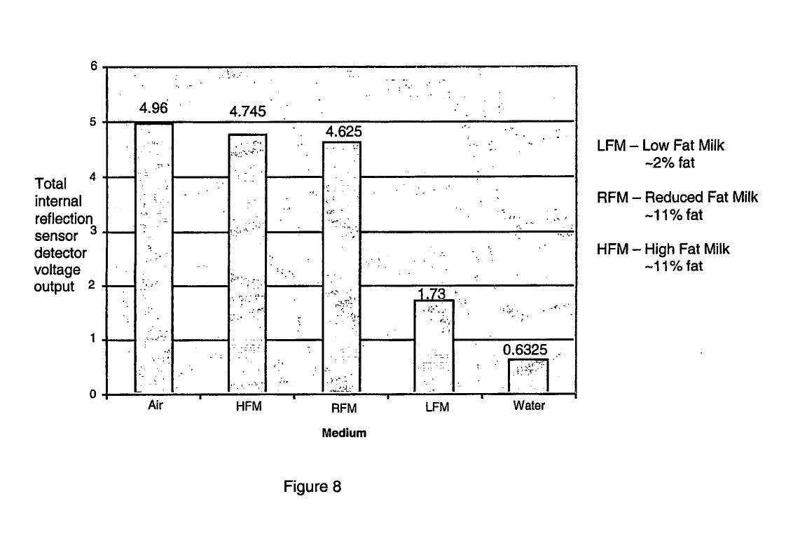

The total internal reflection sensor (34) is thus also employed to resolve this ambiguity. The emitter (35) is orientated with respect to the detector (33) such that with air present in the well (4), a light ray (37) from the emitter (35) is totally internally reflected by the inner surface (38) of the wall of the sample well (4) towards the detector (33). In practice, the emitter (35) and detector (33) are arranged substantially symmetrically to each other about an axis orthogonal to the reflectance surface. The principles of total internal reflection are well established as discussed earlier. When differing substances (with different refractive indices) are present in the well (4), the intensity of the reflected light received by the detector (33) is reduced as a proportion of the light is refracted into the well (4). FIG. 8 shows the mean voltage output of the total internal reflectance detector (33) for the same substances measured for the transmission sensor (31). The two sets of results enable a set of data records to be established for different mediums, and enable subsequent measurements to be compared to the data records for identification of the medium.

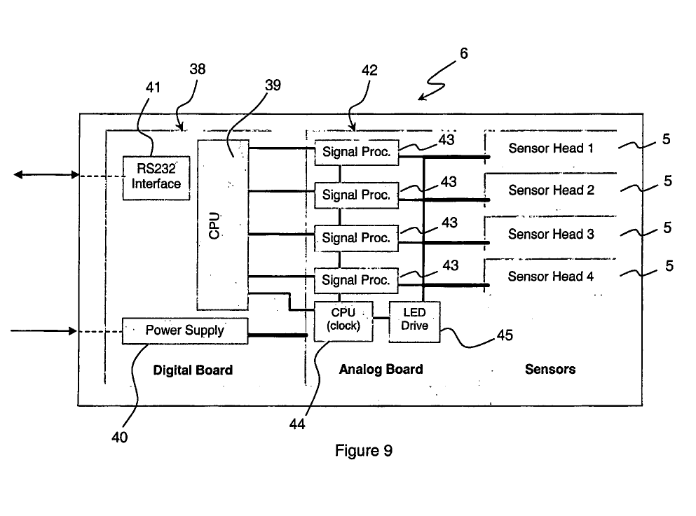

As shown in FIG. 9, the fluid sensor (5) is controlled and operated in this embodiment by a fluid controller (6) in the form of;
a digital controller (38) controlling communications protocols, sampling and processing (and converting to digital) of the analogy signals received from the sensors (5), including a;
   processor (39);
   power supply (40)
   RS232 communication interface (41)
an analogue controller (42) providing drive for the fluid sensors (5) and processing the received signals from the detectors (33) and including;
   signal processors (43) for each fluid sensor (5)
   processor clock (44);
   LED drive circuitry (45)
fluid sensors (5) each including;
   two LED emitters (32, 35)
   a photodiode detector (33).

The effects of ambient light on the measurements are removed by sampling the detector signal (33) when the LED emitters are off and (separately) subtracting the measured ambient light signal from the transmission and total internal reflection signals.

Thus the present invention provides a sampler (1) including a fluid sensor system capable of sensing the presence and/or state of said single-phase fluid or gas at a predetermined level in the collection recess (4), said fluid sensor system includes at least two distinct sensors respectively capable of utilising distinct properties of the fluid or gas (3) to determine the presence and/or state of the sample volume present in the collection recess (4).

Although the above embodiments have described the use of optical transmission sensor (31) and a total internal reflection sensor (34), it will be appreciated that a variety of fluid sensor (5) types may be incorporated into the fluid sensor system utilising said distinct properties of the fluid or gas include transmission/absorption, refractive index, reflectance, back-scattering, opacity, capacitance, inductance, conductivity, electrical resistance, dielectric constant, ultrasonic, magnetic or acoustic.

The use of at least two sensors (5) utilising different properties of the fluid or gas permits the characteristics of the sensors (5) to be matched with the characteristics of the type sample volume desired for extraction and sampling.

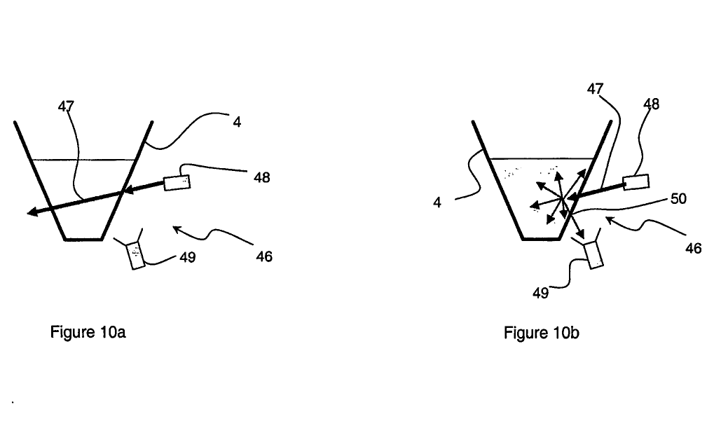

FIG. 10 a)-b) shows a schematic representation of an optical backscattering sensor (46), in which a light ray (47) emitted from an emitter (48) (such as an NIR LED) passes into the sample well (4). In FIG. 10 a) the well (4) collection recess contains a transparent fluid or gas and thus the light (47) is transmitted straight through the well (4) without back scattering. FIG. 10 b) shows the sample well (4) filled with an opaque fluid such as milk, which causes some of the incident light (47) to be scattered with some light (50) being reflected back towards a detector (49) positioned on the same side of the well (4) as the emitter (48). The degree of back scattering is a function of the interaction of the light with matter in the fluid. Consequently, the back scattering sensor can be used to supply indicative information on the presence and/or state of fluid or gas in the sample well (4).

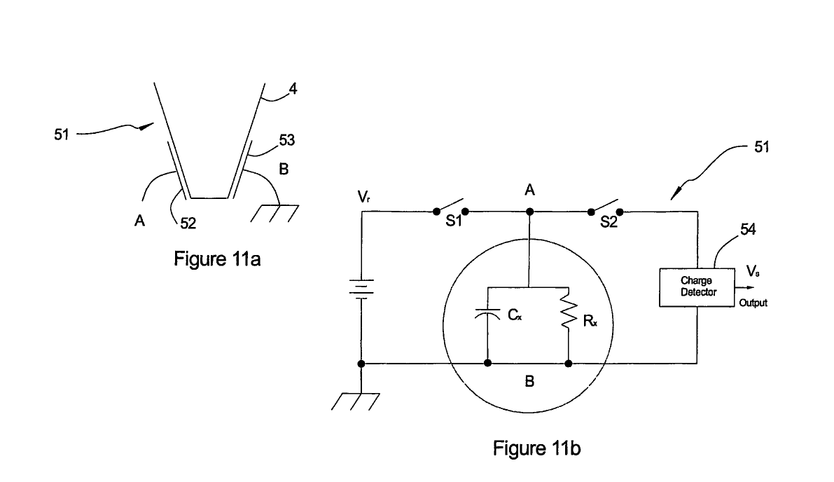

FIG. 11 a-b) shows a further sensor alternative in the form of a capacitance sensor (51) whereby a pair of electrode plates (52, 53) are arranged either side of the well (4). The contents of the sample well (4) determine the dielectric constant between the plates (52, 52), enabling the variations in the measured dielectric constant with different well (4) contents to help determine the presence and/or state of different fluids or gas in the well (4). The plates (52, 53) may be formed from any electrically conductive material including clear plastic sheet thus enabling the capacitive sensor (51) to be used with other optical sensor types.

Capacitance changes with the dielectric of the substance between the plates (52, 52) and thus as an empty sample well fills with water, capacitance will change monotonically.

According to different embodiments, the capacitance may be measured by different methods including impedance measurement and charge transfer. FIG. 11b) shows an equivalent electrical circuit to FIG. 11 a) for a charge transfer method, where Cx and Rx represent the impedance presented by the plates (52, 53) to the circuit.

A sense plate (52) (point A) is charged to a fixed potential by closing and opening switch S1 for a short period before the charge is transferred (by closing and opening switch S2 for a short period) to a charge detector (54), the capacitance of the sense electrode (52) can be determined. The charge detector (54) is essentially a known capacitor made much larger then the expected value of Cx. Adjustment of the transfer and switching times according to known techniques enables the charge transfer method to avoid problems suffered by the impedance measurement method with the build-up of a milk residue on the inside of the well (4) adjacent the plates which otherwise distorts the sensor's accuracy.

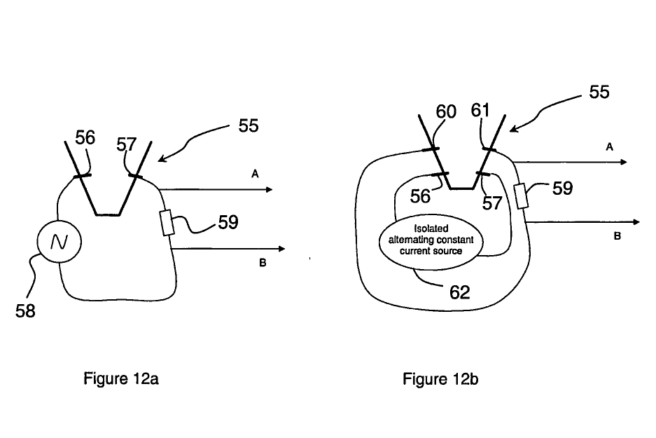

FIG. 12 a) and b) respectively show variants of conductivity probes sensors (55) which may also be implemented in the present invention as part of the fluid sensor system. FIG. 12 a) shows a conductivity sensors (55) with two-probes (56, 57) arranged on opposing sides of the sample well (4) and positioned to protrude through the well wall into the sample well void. Both probes are connected to an isolated AC supply (58) and a load resister (59). As the impedance of any substance in the sample well (4) reduces more current flows through the load resistor (59). Consequently, the voltage over the load resistor (59) (between points A and B) increases, indicating the presence of a fluid. However, a thin film of highly conductive fluid can also produce similar conductivity results as a sample well (4) full of a less conductive fluid.

FIG. 12 b) shows a conductivity sensor (55) and four probes (56, 57, 60, 61) which addresses the problem of residue build-up on sensors (55) with two-probes (56, 57). The probes are arranged in pairs, with a lower pair (56, 57) connected to a constant current source (62). An upper pair of probes (60, 61) is connected to the load resister (59) and the resulting voltage produced by the electric field across the resister (59) at points A B measured. Residue/dirt build up effects are minimised with the constant current probes (56, 57), as it they are simply driven harder to overcome any increase in resistance without affecting the measurement accuracy. The voltage probes (60, 61) are high impedance and thus not significantly affected by a layer of residue/dirt.

Thus, for an embodiment such as a typical milk line where the fluid-flow system may include milk (single phase and froth), air, cleaning fluid such as wash water, or tap water in addition to a film or residue of tap water, wash water or milk, it can be seen that several sensor types may be utilised.

As shown in table 1 above, each of the example sensors given may exhibit different response outputs to different mediums. Selection of the sensor types is thus driven by the substance desired as a sample volume for extraction and also any substances or phases that need to be identified to ensure extraction does not occur if they are present in the sample well (4).

Aspects of the present invention have been described by way of example only and it should be appreciated that modifications and additions may be made thereto without departing from the scope thereof.

1. A sampler capable of extracting sample volumes of substantially single-phase fluid or gas from a fluid-flow system containing multi-phase fluids, said sampler including;
a collection recess adapted to separate substantially single-phase fluid from said multi-phase fluid;
an extraction outlet in said collection recess;
at least one fluid sensor system capable of sensing the presence of a minimum volume of said single-phase fluid or gas in the collection recess, and
a fluid controller capable of controlling flow from the collection recess via said extraction outlet;
characterised in that
a sample volume of said single-phase fluid or gas is obtainable by operating the fluid controller to allow the sample volume to flow through the extraction outlet after said fluid sensor has detected the presence of said minimum volume of single-phase fluid or gas in the fluid collection recess.

2. A sampler as claimed in claim 1, further including a pump controlled by said fluid controller to extract said sample volume from the collection recess.

3. A sampler as claimed in claim 1, further including a valve controlled by said fluid controller to allow the sample volume to pass from the collection recess.

4. A sampler as claimed in claim 1 wherein the fluid sensor is configured as a fluid level detector.

5. A sampler as claimed in claim 4, wherein said level detector is positioned to detect the presence of single-phase fluid at a position in the collection recess indicative of sufficient single-phase fluid volume to extract said defined volume sample.

6. A sampler as claimed in claim 1, wherein additional fluid level detectors are employed to provide data on fluid level change and/or rate of fluid level change.

7. A sampler as claimed in claim 1, wherein the fluid sensor is capable of continuously measuring the absolute single-phase fluid level within the collection recess.

8. A sampler as claimed in claim 1, wherein the fluid sensor is configurable to detect the absence of fluid or gas, including single or multi-phase fluid, at said predetermined level in the collection recess.

9. A sampler for extracting sample volumes of substantially single-phase fluid or gas from a fluid-flow system containing multi-phase fluids, said sampler including;
a collection recess adapted to separate substantially single-phase fluid from said multi-phase fluid;
an extraction outlet in said collection recess;
at least one fluid sensor system capable of sensing the presence and/or state of said single-phase fluid or gas in the collection recess; and
a fluid controller capable of controlling fluid or gas flow from the collection recess via said extraction outlet;
characterised in that said fluid sensor system includes
at least two distinct sensors respectively capable of utilising distinct properties of the fluid or gas to determine the presence and/or state of the sample volume present in the collection recess.

10. A sampler as claimed in claim 9, wherein said properties of the fluid or gas include transmission/absorption, refractive index, reflectance, back-scattering, opacity, capacitance, inductance, conductivity, electrical resistance, dielectric constant, ultrasonic, magnetic or acoustic.

11. A sampler as claimed in claim 9, wherein said fluid sensor system includes;
a total internal reflection sensor including an emitter and a detector, and
a transmission sensor including an emitter and a detector arranged on substantially opposing sides of the collection recess.

12. A sampler as claimed in claim 9, wherein the state of a sample volume determined by the fluid sensor system includes at least one of; single phase fluid, froth, or gas.

13. A sampler as claimed in claim 11, wherein the total internal reflection sensor emitter and detector are orientated towards a common point on a wall of the collection recess and positioned substantially symmetrically either side of an axis orthogonal to the wall and passing through said common point.

14. A sampler as claimed in claim 1, wherein a predetermined or minimum sample volume of said single-phase fluid or gas is obtainable by operating the fluid controller to allow fluid to flow through the extraction outlet for a predetermined period after said fluid sensor system has detected the presence of a predetermined minimum volume of single-phase fluid or gas in the collection recess.

15. A sampler as claimed in claim 11, wherein the total internal reflection sensor and transmission sensor use one of more common emitters and/or detectors.

16. A sampler as claimed in claim 11, wherein each sensor includes an individual emitter and a single detector common to both sensors.

17. A sampler as claimed in claim 11, wherein at least one emitter is a near infra red (NIR) LED.

18. A sampler as claimed in claim 11, wherein the detector is a photo-diode.

19. A sampler as claimed in claim 11, wherein the total internal reflection and/or the transmission sensor are/is located at a predetermined level in the collection recess corresponding to said minimum sample volume.

20. A sampler as claimed in claim 9, wherein the fluid controller incorporates a processor capable of receiving output signals from all the fluid sensor system sensors and comparing said outputs with predetermined reference data to determine whether single phase fluid, froth, or gas is present in the collection recess.

21. A sampler as claimed in claim 11, wherein the total internal reflection sensor is configured such that light emitted from emitter is totally internally reflected to the detector when air is present in the collection recess.

22. A sampler as claimed in claim 21, wherein a least part of the light emitted from emitter is refracted into the collection recess and a consequently reduced intensity light signal is received by the detector when fluid is present in the collection recess.

23. A sampler as claimed in claim 11, wherein said fluid sensor system further includes an analogue and digital controllers, said analogue controller capable of processing output signals from said detectors and providing an input signal to said emitters, said digital controller incorporates said processor and interfaces with the analogue controller to receive, process and convert the analogue signals into equivalent digital signals, before the processor compares the detectors outputs with said data records to determination the state of the substance.

24. A sampler as claimed in claim 23, wherein the processor outputs a signal to a display indicating the phase of the medium in the sample recess.

25. A sampler as claimed in claim 23, wherein upon detection of a specific medium in the collection recess, the processor operates a pump to allow said minimum volume of fluid or gas to flow through the extraction outlet.

26. A sampler as claimed in claim 11, wherein the input of ambient light on the fluid sensor measurements is eliminated.

27. A sampler as claimed in claim 11, wherein the detector output measured with all emitter switched off is subtracted from the detector outputs measured when a transmission emitter or total internal reflection emitter is on.

28. A sampler as claimed in claim 1, wherein upon detection by the fluid sensor of the absence of said fluid, the fluid controller may activate said pump or valve to allow the passage of non-dissolved gas to form a substantially non-fluid buffer between single fluid samples.

29. A sampler as claimed in claim 10, wherein the opacity of any fluid in the collection recess is determined by the fluid sensor system by comparison of the fluid sensor system detector output with said data records to identify the presence of single phase milk, water, cleaning fluid, or a combination of same.

30. A sampler as claimed in claim 1, wherein the detection by the fluid sensor system of the absence of said fluid in the collection recess instigates an evacuation of the collection recess and extraction outlet by pumping un-dissolved gas or a cleaning fluid through any sampler fluid paths.

31. A sampler as claimed in claim 1, wherein an entrance to the collection recess from the fluid flow system is raised from the lowermost position of fluid flow in the fluid flow system.

32. A sampler as claimed in claim 31, wherein for a fluid flow system in the form of a cylindrical tubular conduit, the entrance to the collection recess is raised by rotating the conduit about its longitudinal axis by less than 90°, thus rotating the collection recess from the lowermost point of the conduit.

33. A sampler as claimed in claim 32, wherein a raised rim is formed about the collection recess entrance.

34. A sampler as claimed in claim 1, wherein the sample volumes extracted from the collection recess are temporarily retained in a storage vessel before transportation to a sample processor.

35. A sampler as claimed in claim 34, wherein said sample storage vessels are fluid conduits connected to corresponding collection recess extraction outlets.

36. A sampler as claimed in claim 34, wherein at least one additional fluid sensor is incorporated into the sampler at a downstream position from the extraction outlet.

37. A sampler as claimed in claim 32, wherein said additional fluid sensor is located in said storage vessel.

38. A sampler as claimed in claim 1, wherein said sampler further includes a sample processor for performing mastitis detection, said sample processor including; an inlet from one or more sample storage vessels; a mixing chamber, with a reagent inlet and an outlet draining to a flow chamber.

39. A sampler as claimed in claim 9, wherein said at least two distinct sensors are capable of distinctive outputs from sensing the sample volume in comparison to sensing any other components of said multi-phase fluid in the fluid flow system.

40. A sampler as claimed in claim 9, capable of intermittent extraction of a specific fluid or gas or a specific phase of fluid/gas from a multi flow system, said extraction being halted during periods when one or more unwanted fluid/gas phases are present in the collection recess.

41. A sampler as claimed in claim 1, wherein extraction of the sample volume is delayed for a predetermined period after commencement of fluid flow in the fluid flow system.

42. A sampler as claimed in claim 40, wherein commencement of fluid flow is signalled to the sampler from an external source.

43. A sampler as claimed in claim 1, wherein the fluid controller may activate said pump or valve to allow the passage of non-dissolved gas to form a substantially non-fluid buffer between individual fluid sample volumes.

44. A sampler as claimed in claim 1, wherein the fluid controller may activate said pump or valve to allow the passage of fluid to form fluid buffers between individual gas sample volumes.

45. A sampler as claimed in claim 13, wherein a predetermined or minimum sample volume of said single-phase fluid or gas is obtainable by operating the fluid controller to allow fluid to flow through the extraction outlet until
a predetermined time has elapsed;
a pump operable by the fluid controller has pumped said minimum volume from the collection recess;
a second level sensor located at a lower point in the collection recess indicates the absence of the sample volume fluid or gas; and/or
a flow rate sensor monitoring flow from the extraction outlet indicates flow has dropped below a predetermined level.

46. A method of intermittent extraction of a specific fluid or gas or a specific phase of fluid/gas from a multi flow system using the sampler as claimed in claim 9, said extraction being halted during periods when one or more unwanted fluid/gas phases are present in the collection recess.

47. A method as claimed in claim 46, wherein extraction of the sample volume is delayed for a predetermined period after commencement of fluid flow in the fluid flow system.

48. A method of configuring a sampler as claimed in claim 11, said method including;
selecting said two or more sensors for the fluid sensor system such that sensing the presence and/or state of a sample volume for subsequent extraction from the collection recess produces a distinct out put from the fluid sensor system sensors in comparison to sensing any other components of said multi-phase fluid in the fluid flow system sensed in the collection recess.

49. A testing method to aid in the detection of mastitis, said method characterised by:
sensing the presence of single-phase fluid in the collection recess at a predetermined height;
activating said pump for a predetermined period to extract a defined or minimum volume of single-phase fluid sample via the fluid extraction outlet;
transporting the fluid sample to the mixing chamber in said sample processor;
mixing a reagent with the fluid sample to form a gel;
obtaining an indication of somatic cell numbers by measuring the time the gel needs to drain through a defined exit hole; and
determining if the drain time exceed a predetermined threshold value or range of values.

50. A method as claimed in claim 49, wherein said viscosity measurement is performed by monitoring the time taken to drain the gel though a fixed size outlet.

51. A method as claimed in claim 49, wherein one or more fluid sample(s) is/are temporarily stored in one or more sample storage vessel(s) before transportation to the sample processor.

52. A method of sensing single-phase fluid, froth, or gas medium in a collection recess of a sampler, said method including:
sensing said medium in the collection recess with said at least two sensors using said distinct properties of the fluid or gas;
outputting the signals detected by said two or more sensors to the fluid controller; and
comparing the detected signals with data records relating to single phase fluids, froth and/or gas to determine the medium present in the collection recess.

53. A method of sensing single-phase fluid, froth, or gas medium in a collection recess of a sampler, said method including:
emitting light from the transmission sensor emitter into the collection recess and detecting with the transmission sensor detector the light transmitted through the collection recess;
emitting light from the total internal reflection sensor emitter and detecting with the total internal reflection sensor detector the light totally internally reflected from the wall of the collection recess;
outputting the signals detected by the transmission and total internal reflection sensor detector(s) to the fluid controller; and
comparing the detected signals with data records relating to single phase fluids, froth and/or gas to determine the medium present in the collection recess.

54-57. (canceled)
